(19) United States
(12) Patent Application Publication
(10) Pub. No.: US 2026/0209094 A1
(43) Pub. Date: Jul. 23, 2026

(54) PRODUCED WATER TREATMENT

(71) Applicant: Saudi Arabian Oil Company, Dhahran (SA)

(72) Inventors: Abdulaziz Y. AlAmmar, Dammam (SA); Sarah Almahfoodh, Anak (SA); Young Chul Choi, Dhahran (SA)

(21) Appl. No.: 19/034,061

(22) Filed: Jan. 22, 2025

(51) Int. Cl. C02F 9/00; B01D 17/02; B01D 61/14; B01D 69/02; B01D 71/02; C02F 1/24; C02F 1/40; C02F 1/44; C02F 101/32; C02F 103/10

(52) U.S. Cl. CPC C02F 9/00; B01D 17/0205; B01D 17/0211; B01D 61/147; B01D 69/02; B01D 71/02; B01D 2315/08; B01D 2325/02834; C02F 1/24; C02F 1/40; C02F 1/444; C02F 2101/32; C02F 2103/10

(57) ABSTRACT

Oil is separated from produced water by a corrugated plate interceptor to produce a first pretreated water stream. Oil is separated from the first pretreated water stream by a dissolved gas flotation unit to produce a second pretreated water stream. A ceramic membrane microfilter is operated in a dead-end mode to separate particulates from the second pretreated water stream to produce a treated water stream.

### TECHNICAL FIELD

This disclosure relates to water treatment, and in particular, produced water treatment.

### BACKGROUND

Considerable amounts of water can be produced as a by-product of oil and gas production processes. The produced water is treated so that it can, for example, be safely discharged into a body of water or re-injected into a reservoir. Produced water treatment can include various processes to separate undesirable substances from the produced water. Some examples include de-oiling, removing total dissolved solids, and softening.

### SUMMARY

This disclosure describes technologies relating to produced water treatment. The subject matter described in this disclosure can be implemented in particular implementations, so as to realize one or more of the following advantages. The systems and methods described process produced water to remove oil, suspended solids, and other contaminants. The systems and methods described use a ceramic membrane, and specifically a ceramic membrane microfilter, operated in dead-end mode to process produced water. The ceramic membrane can be used at high temperatures (greater than 35° C., such as about 60° C.) to process produced water. By integrating ceramic membrane microfiltration with other technologies, such as dissolved gas flotation and corrugated plate interceptors, the systems and methods can process high volumes of produced water to generate treated water that can be reused and/or safely disposed. The systems and methods described provide various operational benefits, such as reducing footprint due to the efficient use of space, reduced operational costs by saving on chemical and energy consumption, and improved compliance with environmental discharge standards for subterranean wells. The systems and methods described offer flexibility in process design and optimization. Such versatility is particularly beneficial with respect to processing produced water because the characteristics of produced water can vary widely based on various factors, such as location and composition of rock formation from which the produced water originates. The systems and methods described allow for crude oil processing systems (such as gas-oil separation plants) to meet water quality targets (e.g., oil-in-water content and total suspended solids content) consistently for injection water.

The details of one or more implementations of the subject matter of this disclosure are set forth in the accompanying drawings and the description. Other features, aspects, and advantages of the subject matter will become apparent from the description, the drawings, and the claims.

### DESCRIPTION OF DRAWINGS

FIG. 1A is a schematic diagram of an example system for treating produced water.

FIG. 1B is a schematic diagram of an example system for treating produced water.

FIG. 2 is a flow chart of an example method for treating produced water.

FIG. 3 is a schematic diagram of an example system for treating produced water.

FIG. 4 is a flow chart of an example method for treating produced water.

FIG. 5 is a schematic diagram of an example system for treating produced water.

FIG. 6A is a plot showing permeate flux and operating pressure over time for an example ceramic membrane treating produced water.

FIG. 6B is a bar graph representing various properties of the feed and permeate for the example ceramic membrane of FIG. 6A.

FIG. 7A is a plot showing permeate permeance and operating temperature over time for an example ceramic membrane treating produced water.

FIG. 7B is a bar graph representing various properties of the feed and permeate for the example ceramic membrane of FIG. 7A.

FIG. 8A is a plot showing permeate flux and operating pressure over a longer period of time in comparison to the example shown in FIG. 6A for an example ceramic membrane treating produced water.

FIG. 8B is a bar graph representing various properties of the feed and permeate for the example ceramic membrane of FIG. 8A.

### DETAILED DESCRIPTION

In the oil and gas industry, the production of hydrocarbons is often accompanied by the generation of large volumes of produced water, which is a mixture of formation water, injection water, and various contaminants. The separation of produced water, oil and/or gas can take place in the gas and oil separation plants (GOSPs). The amount of produced water obtained can increase as the oilfield ages. A large portion of this produced water from the GOSPs is typically sent to injection wells for pressure maintenance or disposal. Proper treatment and disposal of produced water are crucial for environmental protection and regulatory compliance.

This disclosure describes produced water treatment, for example, in GOSPs. The described system integrates a corrugated plate interceptor (CPI) unit, a dissolved gas flotation (DGF) unit, and a ceramic microfiltration (MF) membrane. The produced water can be treated by the CPI unit, then the DGF unit, and then the ceramic MF membrane. This integration significantly improves removal efficiency of suspended particulates and other contaminants, rendering the discharge water suitable for well disposal and/or injection into oil wells to enhance oil recovery (for example, by pressure maintenance). The described system can be easily integrated into existing produced water treatment infrastructures. The described system offers enhanced durability and cost-effectiveness in water treatment in GOSPs. Implementing the described system can reduce requirements for drilling new wells, reduce frequency of well workovers, reduce energy costs, and improve water quality. Improvement of water quality of produced water that is treated and injected into wells can mitigate and/or prevent damage to the well formation. In some implementations, the sludge removed by the ceramic MF membrane is dewatered and/or solidified before disposal, for example, in a landfill. In some implementations, the sludge removed by the ceramic MF membrane is recycled to the produced water (feed) that enters the CPI unit.

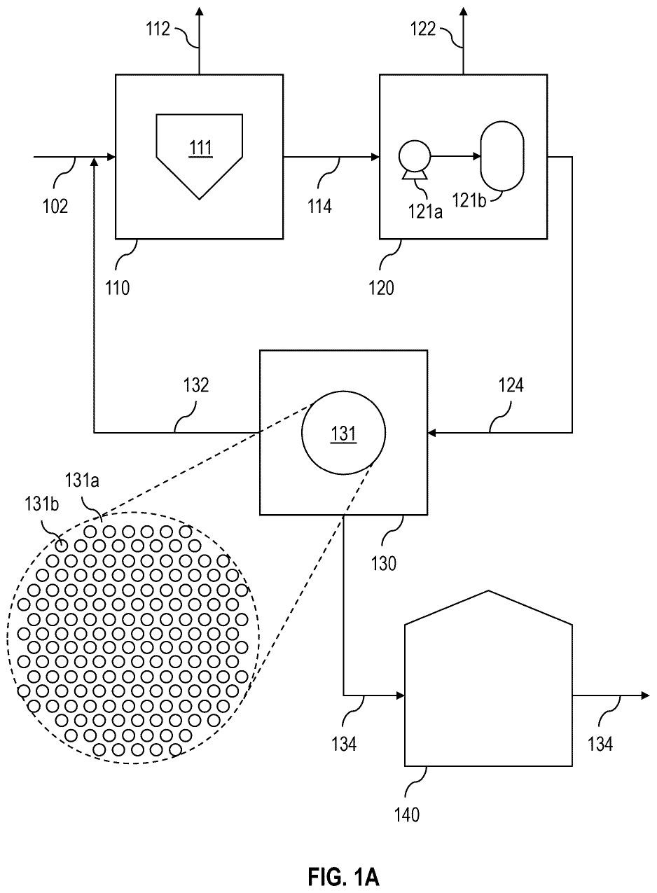

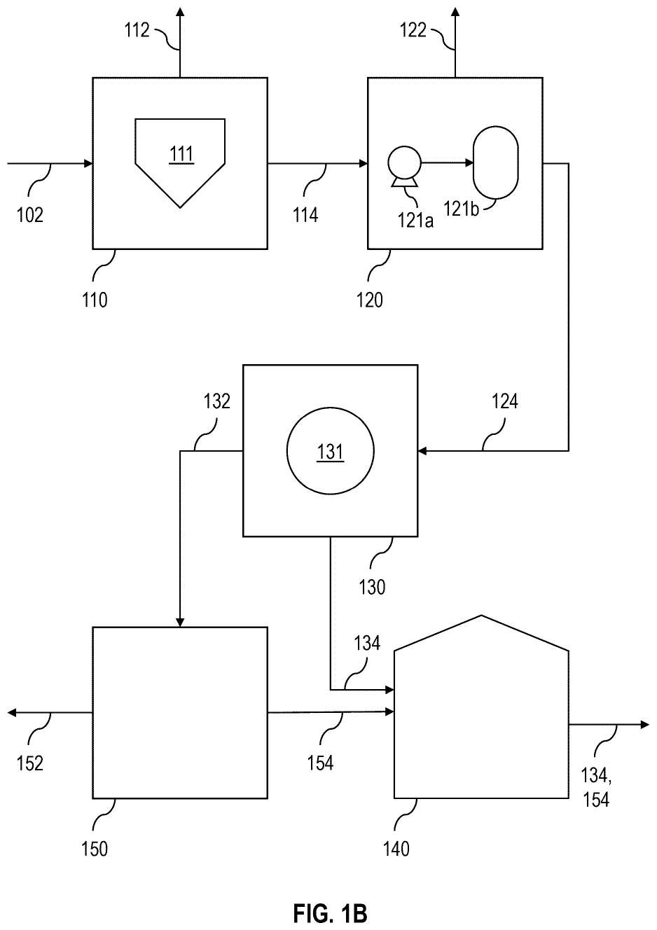

FIG. 1A is a schematic diagram of an example system 100A for treating produced water. The system 100A includes a corrugated plate interceptor (CPI) unit 110, a dissolved gas flotation (DGF) unit 120, and a ceramic membrane microfiltration (MF) unit 130. A produced water stream 102 flows to the CPI unit 110. The CPI unit 110 is configured to receive the produced water stream 102 and separate a first oil stream 112 from the produced water stream 102 to produce a first pretreated water stream 114. The first pretreated water stream 114 flows from the CPI unit 110 to the DGF unit 120. The DGF unit 120 is configured to receive the first pretreated water stream 114 and separate a second oil stream 122 from the first pretreated water stream 114 to produce a second pretreated water stream 124. The second pretreated water stream 124 flows from the DGF unit 120 to the ceramic membrane MF unit 130. The ceramic membrane MF unit 130 is configured to receive the second pretreated water stream 124 and separate sludge 132 from the second pretreated water stream 124 to produce a treated water stream 134. In some implementations, the sludge 132 is recycled and mixes with the produced water stream 102 upstream of the CPI unit 110 and enters the CPI unit 110 along with the produced water stream 102 for additional processing. In some implementations, the sludge 132 is disposed. The first oil stream 112 and the second oil stream 122 can, for example, be flowed to another unit (such as the GOSP) for further processing and can contribute to the overall yield of oil.

The produced water stream 102 includes produced water from a wellbore formed in a subterranean formation. Produced water is water that exists in subterranean formations and can be brought to the surface during oil and gas production. The composition of produced water depends on the type and location of the subterranean formation from which the produced water was produced. Further, the composition of produced water can change over the life of the well from which the produced water is produced. Produced water typically contains oil and suspended solids. In some cases, produced water can include heavy metals, such as zinc, lead, manganese, iron, and barium. The produced water stream 102 includes at least a portion of the produced water that has been separated (for example, by a GOSP) from the hydrocarbons that have been produced from the well.

In some implementations, the produced water stream 102 has an operating temperature in a range of from about 55 degrees Celsius (° C.) to about 75° C. For example, the produced water stream 102 has an operating temperature of about 60° C. In some implementations, the produced water stream 102 flows to the CPI unit 110 at a flow rate in a range of from about 300,000 barrels per day (about 47,696 cubic meters per day) to about 800,000 barrels per day (about 127,190 cubic meters per day). For example, the produced water stream 102 flows to the CPI unit 110 at a flow rate of at least 300,000 barrels per day (about 47,696 cubic meters per day). For example, the produced water stream 102 flows to the CPI unit 110 at a flow rate of up to about 800,000 barrels per day (about 127,190 cubic meters per day). For example, the GOSP processes specified amount of crude oil to generate the produced water stream 102 having a flow rate in a range of from about 300,000 barrels per day (about 47,696 cubic meters per day) to about 800,000 barrels per day (about 127,190 cubic meters per day), which is provided to the CPI unit 110. In some implementations, the produced water stream 102 has an oil content in a range of from about 50 parts per million (ppm) to about 1,000 ppm. For example, the produced water stream 102 has an oil content of up to about 1,000 ppm. For example, the produced water stream 102 has an oil content of at least about 50 ppm. In some implementations, the produced water stream 102 has a total suspended solids (TSS) content in a range of from about 20 ppm to about 300 ppm. For example, the produced water stream 102 has a TSS content of up to about 300 ppm. For example, the produced water stream 102 has a TSS content of at least about 20 ppm. In some implementations, the produced water stream 102 has a turbidity in a range of from about 10 nephelometric turbidity units (NTU) to about 250 NTU. For example, the produced water stream 102 has a turbidity of up to about 250 NTU. For example, the produced water stream 102 has a turbidity of at least about 10 NTU.

The CPI unit 110 includes a CPI 111. The CPI 111 is configured to separate phases (such as oil and water) of a multiphase fluid (such as the produced water stream 102). The CPI 111 includes corrugated plates that are tilted at a specified downward angle in a generally parallel configuration to separate phases (such as oil and water) of a fluid (such as the produced water stream 102). The corrugated plates of the CPI 111 have wavy or ridged surfaces which can facilitate separation of phases of a multiphase fluid (for example, an oil-in-water emulsion, such as the produced water stream 102). The produced water stream 102 flows through the spaces between the corrugated plates of the CPI 111, the lighter phase (such as oil) tends to float while the heavier phase (such as water) tends to settle due to gravity. The oil (for example, in the form of droplets) slides up the corrugated plates and forms an oil layer at the top of the fluid level within the CPI 111 while the water continues to flow down the corrugated plates and exits the CPI 111 as the first pretreated water stream 114 through a water outlet. The oil layer accumulating at the top of the fluid level within the CPI 111 is skimmed and exits the CPI 111 as the first oil stream 112 through an oil outlet. In some cases, the CPI 111 includes at least one weir to facilitate separate of the phases of the produced water stream 102. Weir(s) of the CPI 111 can enhance phase separation and can facilitate maintenance of fluid levels within the CPI 111. Increasing the residence time of the produced water stream 102 through the CPI 111 can improve separation of phases (such as oil, water, and sludge) of the produced water stream 102. In some implementations, the CPI 111 is operated at ambient temperature, such as an operating temperature in a range of from about 15° C. to about 75° C. In some implementations, the CPI 111 is operated at a low pressure, such as an operating pressure in a range of from about 10 kilopascals (kPa) to about 50 kPa. In some implementations, the CPI 111 receives and processes the produced water stream 102 flowing to the CPI 111, for example, at a rate in a range of from about 50 cubic meters per hour to about 2,000 cubic meters per hour. In some implementations, the first pretreated water stream 114 includes about 100 ppm of oil. In some implementations, the first pretreated water stream 114 produced by the CPI 111 has a water content of at least 99.95 volume percent (vol. %). In some implementations, the first oil stream 112 produced by the CPI 111 has an oil content in a range of from about 10 vol. % to 100 vol. %.

The DGF unit 120 is configured to separate phases (such as oil and solids) from a multiphase fluid (such as, in some cases, the first pretreated water stream 114). The DGF unit 120 dissolves gas into the multiphase fluid under pressure, and the dissolved gas is then released to form bubbles which can attach to contaminants (such as oil and solids) to separate the contaminants from the bulk fluid (e.g., water). The DGF unit 120 includes a DGF pump 121a and a vessel 121b. The DGF pump 121a is configured to receive the first pretreated water stream 114 from the CPI unit 110. The DGF pump 121a includes impellers that are rotated by a motor. The rotating impellers of the DGF pump 121a are configured to flow the first pretreated water stream 114 to the vessel 121b. The impellers of the DGF pump 121a can include dual sides. A first side of the impellers of the DGF pump 121a can, for example, be designed to drive liquid (such as the first pretreated water stream 114) like a typical centrifugal pump. A source of gas (for example, air or nitrogen) can be provided to the DGF pump 121a. A second side of the impellers of the DGF pump 121a can, for example, be designed to draw gas from the gas source and mix the gas with the liquid (such as the first pretreated water stream 114). The rotating impellers of the DGF pump 121a draw in gas from the gas source, and the gas mixes with the first pretreated water stream 114. The gas is compressed and sheared into micro-fine bubbles which dissolve into the first pretreated water stream 114. The first pretreated water stream 114 including the dissolved gas flows to the vessel 121b. The vessel 121b operates at a lower pressure (for example, atmospheric pressure), and the dissolved gas begins to bubble out of the solution (such as the first pretreated water stream 114). The gas bubbles that form float to the surface (liquid level) and facilitate separation of phases of the first pretreated water stream 114 (such as oil and water). For example, the floating gas bubbles adhere to oil droplets (and in some cases, to solid particulates) in the first pretreated water stream 114 and facilitate the oil droplets to float to the surface within the vessel 121b. The oil phase can be skimmed and exit the vessel 121b as the second oil stream 122 through an oil outlet. The water phase can exit the vessel 121b as the second pretreated water stream 124, for example, through a water outlet (for example, located near a bottom of the vessel 121b). In some implementations, the second pretreated water stream 124 produced by the DGF unit 120 has an oil content in a range from about 50 ppm to about 1,000 ppm. In some implementations, the second pretreated water stream 124 produced by the DGF unit 120 has a TSS content of about 20 ppm or less. In some implementations, the DGF unit 120 is operated at ambient temperature, such as an operating temperature in a range of from about 15° C. to about 75° C. In some implementations, the vessel 121b is operated at a pressure in a range of from about 300 kPa to about 600 kPa. In some implementations, the DGF unit 120 receives and processes the first pretreated water stream 114 flowing to the DGF unit 120, for example, at a rate in a range of from about 50 cubic meters per hour to about 2,000 cubic meters per hour.

The ceramic membrane MF unit 130 includes a ceramic membrane 131. A zoomed view of the ceramic membrane 131 is shown in FIG. 1A. The ceramic membrane 131 is an artificial membrane made of inorganic materials (such as alumina, titania, zirconia, silicon carbide, or other glassy materials). The ceramic membrane 131 is robust and can operate under harsh operational environments (for example, high temperatures, such as temperature greater than 35° C.) and can remove suspended solids, particulates, and oil droplets from produced water. The ceramic membrane 131 has a surface 131a that defines a plurality of pores 131b. The pores 131b are sized to allow fluid (such as water) to pass through the pores 131b while preventing solid material of a specified size from passing through the pores 131b such that the solid material remains and accumulates on the surface 131a. The fluid that passes through the pores 131b and exits the ceramic membrane 131 at an opposite surface is cleaner (i.e., contains less contaminants) in comparison to the fluid that is introduced to the ceramic membrane 131. Eventually, the ceramic membrane 131 will need to be cleaned to remove the solids that have accumulated on the surface 131a. Pressure drop across the ceramic membrane 131 can be monitored to determine when the ceramic membrane 131 needs to be cleaned. For example, excessive pressure drop across the ceramic membrane 131 can indicate that the ceramic membrane 131 needs to be cleaned.

In some implementations, the ceramic membrane 131 is in the form of a flat sheet or disk. In cases where the ceramic membrane 131 is in the form of a flat sheet or disk, the surface 131a is planar. The pores 131b have pore sizes greater than about 0.1 micrometers (μm). Because the pores 131b have pore sizes (for example, nominal pore size) greater than about 0.1 μm, the ceramic membrane 131 is used for microfiltration. Other types of filtration include, for example, ultrafiltration and nanofiltration. In comparison to microfiltration, ultrafiltration and nanofiltration utilize smaller pore sizes and are therefore able to filter even smaller contaminants from liquids. However, the smaller pore sizes used for ultrafiltration and nanofiltration cause such filtration techniques to be more energy-intensive in comparison to those that employ larger pore sizes (such as microfiltration). In some implementations, the pores 131b have pore sizes in a range from about 0.1 μm to about 10 μm or from about 0.1 μm to about 1 μm.

The ceramic membrane 131 is operated in a dead-end mode in which fluid (such as the second pretreated water stream 124) is flowed perpendicularly to the surface 131a of the ceramic membrane 131. Specifically, the ceramic membrane 131 is a ceramic membrane microfilter that is operated in the dead-end mode. Microfilters are not typically operated in dead-end mode for various reasons. For example, operating microfilters in dead-end mode can cause rapid membrane fouling. As another example, operating microfilters in dead-end mode can cause shorter cycle times, as the absence of cross-flow can lead to buildup of particulates on the membrane surface. In contrast, microfilters are typically operated in cross-flow mode, in which fluid is flowed tangentially (across) the surface of the filter). It was found that the ceramic membrane 131 (with a nominal pore size in the 0.1 μm to 10 μm or 0.1 μm to 1 μm range) could be operated in the dead-end mode to process produced water to specified characteristics, despite typical drawbacks of operating microfilters in dead-end mode. It was found that operating the ceramic membrane 131 in the dead-end mode is particularly useful for processing produced water and water streams originating from produced water. Produced water typically has high levels of TSS and oil. The high levels of TSS and oil present in produced water can aid in the coagulation process, thereby reducing and/or eliminating the need for addition of chemical coagulants. The pore size of the ceramic membrane 131 is selected carefully to maximize filtration efficiency for separating (rejecting) the TSS and oil from the remaining water portion of produced water. Operating the ceramic membrane 131 in the dead-end mode can include operating the ceramic membrane 131 at an operating pressure in a range of from about 50 kPa to about 300 kPa. In some implementations, operating the ceramic membrane 131 in the dead-end mode achieves a permeate flux in a range of from about 0.02 cubic meters per hour per square meter (m³·h⁻¹·m⁻²) to about 0.1 m³·h⁻¹·m⁻².

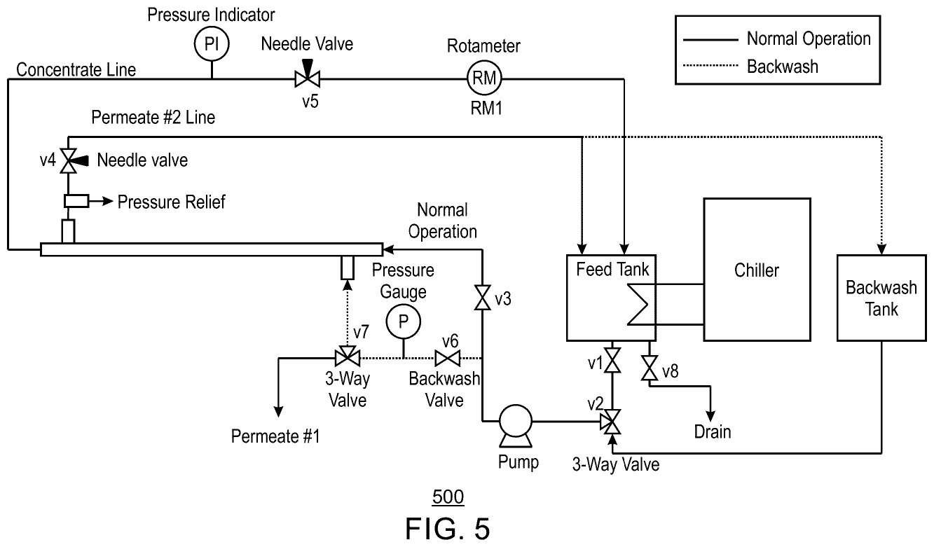

The ceramic membrane MF unit 130 can include a feed pump, a backwash system, and a filtrate tank. An example of the ceramic membrane MF unit 130 is also shown in FIG. 5 as system 500 and is described in greater detail later.

In some implementations, the treated water stream 134 produced by the ceramic membrane MF unit 130 (filtered by the ceramic membrane 131) has an oil content of less than about 10 ppm. In some implementations, the treated water stream 134 produced by the ceramic membrane MF unit 130 (filtered by the ceramic membrane 131) is substantially free of oil. In some implementations, the treated water stream 134 produced by the ceramic membrane MR unit 130 (filtered by the ceramic membrane 131) has an oil content in a range of from 0 ppm to about 10 ppm. In some implementations, the treated water stream 134 produced by the ceramic membrane MF unit 130 (filtered by the ceramic membrane 131) is substantially free of solids. For example, the treated water stream 134 produced by the ceramic membrane MF unit 130 (filtered by the ceramic membrane 131) has a TSS content that is negligible or less than 1 ppm.

The system 100A can include a tank 140. The treated water stream 134 can flow from the ceramic membrane MF unit 130 to the tank 140. The tank 140 can be configured to receive the treated water stream 134 and can be sized to store a specified volume of the treated water stream 134. The treated water stream 134 can flow from the tank 140 to another destination, such as a disposal well or an enhanced oil recovery well.

FIG. 1B is a schematic diagram of an example system 100B for treating produced water (such as the produced water stream 102). The system 100B includes components of system 100A. For example, the system 100B includes the produced water stream 102, the CPI unit 110, the first oil stream 112, the first pretreated water stream 114, the DGF unit 120, the second oil stream 122, the second pretreated water stream 124, the ceramic membrane MF unit 130, the sludge 132, the treated water stream 134, and the tank 140. In addition to those components, system 100B includes a dewatering/solidification unit 150. The sludge 132 produced by the ceramic membrane MF unit 130 is sent to the dewatering/solidification unit 150. The dewatering/solidification unit 150 is configured to receive the sludge 132 and separate solids 152 from the sludge 132 to produce a second treated water stream 154. Similar to the treated water stream 134, the second treated water stream 154 flows to the tank 140. The composition of the second treated water stream 154 can be similar to the composition of the treated water stream 134. In some implementations, the second treated water stream 154 has an oil content of less than about 10 ppm. In some implementations, the second treated water stream 154 is substantially free of oil. In some implementations, the second treated water stream 154 has an oil content in a range of from 0 ppm to about 10 ppm. The solids 152 can be disposed, for example, in a landfill.

The dewatering/solidification unit 150 is configured to receive the sludge 132 from the ceramic membrane MF unit 130. The sludge 132 from the ceramic membrane MF unit 130 may have a non-zero moisture content. The dewatering/solidification unit 150 is configured to remove the moisture from the sludge 132. The dewatering/solidification unit 150 includes a dryer. The dryer can be, for example, a rotary drum dryer that includes a rotating drum. The sludge 132 can be disposed within the rotating drum of the dryer. As the drum rotates, heat can be provided to the sludge 132 to facilitate evaporation of moisture from the sludge 132. The rotating drum can facilitate uniform heating of the sludge 132. In some implementations, a hot gas (such as heated air) is provided to the dryer to directly heat the sludge 132 and facilitate evaporation of the moisture present in the sludge 132. In some implementations, the sludge 132 is indirectly heated within the dryer, and the application of the indirect heat to the sludge 132 within the dryer facilitates evaporation of the moisture present in the sludge 132. In some implementations, a vacuum pump can provide a vacuum within the dryer to facilitate evaporation of the moisture present in the sludge 132. The vapor (for example, water vapor) produced from evaporation of the moisture from the sludge 132 can be collected and condensed to form the second treated water stream 154. The remaining solid material after the moisture has been evaporated is the solids 152, which can be removed from the dryer and disposed, for example, in a landfill. In some implementations, the solids 152 are mixed with cement instead of simply being disposed. In some implementations, the solids 152 are mixed with a binder to create a stable, non-hazardous solid material, which can be used, for example, in the production of soil amendments or construction materials. In some implementations, the solids 152 can be incorporated into a drilling mud for drilling wells.

In some implementations, the dewatering/solidification unit 150 includes a centrifuge that applies centrifugal force (for example, by high-speed rotation) to separate phases of the sludge 132. In some implementations, the dewatering/solidification unit 150 is operated at a pressure in a range of from about 100 kPa to about 500 kPa, for example, in cases where the dewatering/solidification unit 150 includes the centrifuge. In some implementations, the dewatering/solidification unit 150 receives and processes the sludge 132 at a processing rate in a range of from about 1 cubic meter per hour to about 50 cubic meters per hour, for example, in cases where the dewatering/solidification unit 150 includes the centrifuge. In some implementations, the dewatering/solidification unit 150 includes a filter press that applies pressure on the sludge 132 against a filter to separate moisture from the sludge 132. In some implementations, the dewatering/solidification unit 150 is operated at a pressure in a range of from about 500 kPa to about 1,500 kPa, for example, in cases where the dewatering/solidification unit 150 includes the filter press. In some implementations, the dewatering/solidification unit 150 receives and processes the sludge 132 at a processing rate in a range of from about 1 cubic meter per hour to about 20 cubic meters per hour, for example, in cases where the dewatering/solidification unit 150 includes the filter press. In some implementations, the dewatering/solidification unit 150 includes a belt filter press that uses a continuous belt and filter media to remove moisture from the sludge 132. In some implementations, the dewatering/solidification unit 150 is operated at a pressure in a range of from about 100 kPa to about 300 kPa, for example, in cases where the dewatering/solidification unit 150 includes the belt filter press. In some implementations, the dewatering/solidification unit 150 receives and processes the sludge 132 at a processing rate in a range of from about 10 cubic meters per hour to about 100 cubic meters per hour, for example, in cases where the dewatering/solidification unit 150 includes the belt filter press.

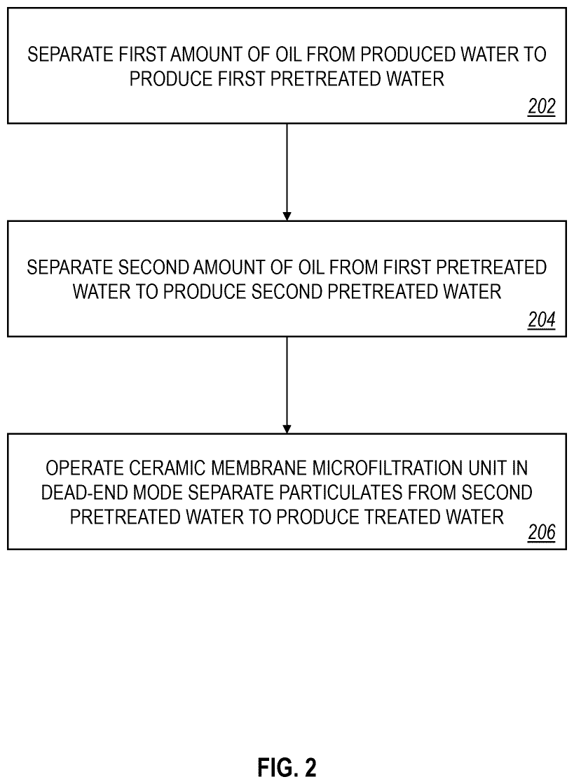

FIG. 2 is a flow chart of an example method 200 for treating produced water (such as the produced water stream 102). The system 100A or 100B can, for example, implement the method 200. At block 202, a first amount of oil (such as the first oil stream 112) is separated from a produced water stream (such as the produced water stream 102) by a CPI unit (such as the CPI unit 110) to produce a first pretreated water stream (such as the first pretreated water stream 114). At block 204, a second amount of oil (such as the second oil stream 122) is separated from the first pretreated water stream 114 by a DGF unit (such as the DGF unit 120) to produce a second pretreated water stream (such as the second pretreated water stream 124). At block 206, a ceramic membrane MF unit (such as the ceramic membrane MF unit 130) is operated in a dead-end mode to separate particulates (such as the sludge 132) from the second pretreated water stream 124 to produce a treated water stream (such as the treated water stream 134). Operating the ceramic membrane MF unit 130 in the dead-end mode includes flowing the second pretreated water stream 124 perpendicularly to a surface (such as the surface 131a) of a ceramic membrane (such as the ceramic membrane 131) of the ceramic membrane MF unit 130. For example, at block 206, the ceramic membrane MF unit 130 is not operated in a cross-flow mode, in which the second pretreated water stream 124 is flowed tangentially across the ceramic membrane 131 (for example, in a direction that is generally parallel to the surface 131a of the ceramic membrane 131).

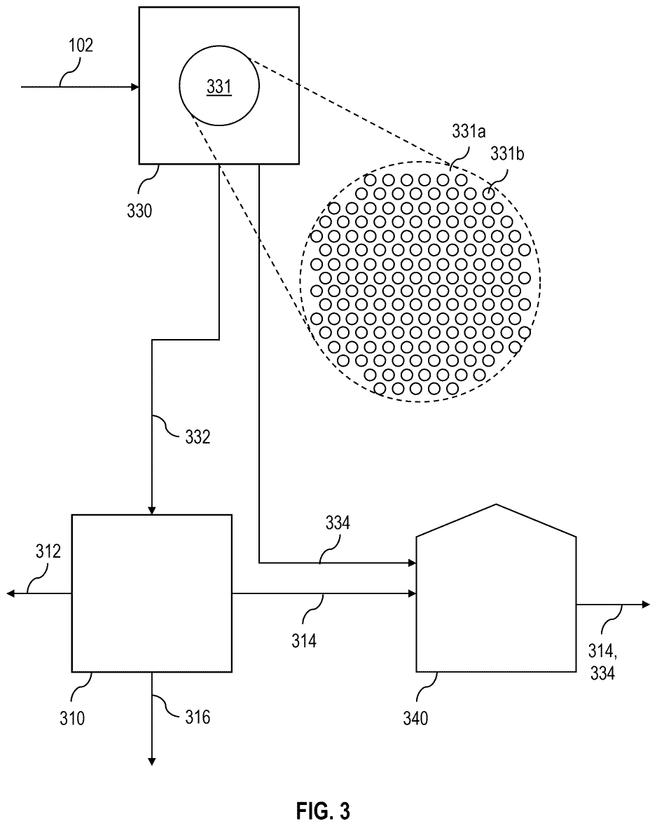

FIG. 3 is a schematic diagram of an example system 300 for treating produced water (such as the produced water stream 102). The system 300 can include components that are similar to those of system 100A. For example, the system 300 includes a ceramic membrane MF unit 330, a CPI unit 310, and a tank 340. The CPI unit 310 can be the same as or similar to the CPI unit 110 of systems 100A or 100B. The ceramic membrane MF unit 330 can be the same as or similar to the ceramic membrane MF unit 330. The tank 340 can be the same as or similar to the tank 140. The produced water stream 102 flows to the CPI unit 310. The ceramic membrane MF unit 330 is configured to receive the produced water stream 102 and separate sludge 332 from the produced water stream 102 to produce a treated water stream 334. The treated water stream 334 can flow to the tank 340 where the treated water stream 334 can be stored and then flowed to another destination, such as a disposal well or an enhanced oil recovery well. The sludge 332 is sent to the CPI unit 310. The CPI unit 310 is configured to receive the sludge 332 and separate phases of the sludge 332 to produce an oil stream 312, a second treated water stream 314, and concentrated sludge 316. The oil stream 312 can, for example, be flowed to another unit (such as the GOSP) for further processing and can contribute to the overall yield of oil. The second treated water stream 314 can flow to the tank 340 where the second treated water stream 314 can be stored and then flowed to another destination, such as a disposal well or an enhanced oil recovery well. The concentrated sludge 316 can be disposed, for example, in a landfill. In some implementations, the concentrated sludge 316 can be dried (for example, by the dewatering/solidification unit 150 shown in FIG. 1B) and mixed with cement or a binder to create a stable, non-hazardous solid material, which can be used, for example, in the production of soil amendments or construction materials. In some implementations, the concentrated sludge 316 can be incorporated into a drilling mud for drilling wells.

Similar to the ceramic membrane MF unit 130, the ceramic membrane MF unit 330 includes a ceramic membrane 331. The ceramic membrane 331 is operated in a dead-end mode. A zoomed view of the ceramic membrane 331 is shown in FIG. 3. The ceramic membrane 331 is an artificial membrane made of inorganic materials (such as alumina, titania, zirconia, silicon carbide, or other glassy materials). The ceramic membrane 331 has a surface 331a that defines a plurality of pores 331b. The pores 331b are sized to allow fluid (such as water) to pass through the pores 331b while preventing solid material of a specified size from passing through the pores 331b such that the solid material remains and accumulates on the surface 331a. The fluid that passes through the pores 331b and exits the ceramic membrane 331 at an opposite surface is cleaner (i.e., contains less contaminants) in comparison to the fluid that is introduced to the ceramic membrane 331. Eventually, the ceramic membrane 331 will need to be cleaned to remove the solids that have accumulated on the surface 331a. Pressure drop across the ceramic membrane 331 can be monitored to determine when the ceramic membrane 331 needs to be cleaned. For example, excessive pressure drop across the ceramic membrane 331 can indicate that the ceramic membrane 331 needs to be cleaned.

In some implementations, the ceramic membrane 331 is in the form of a flat sheet or disk. In cases where the ceramic membrane 331 is in the form of a flat sheet or disk, the surface 331a is planar. The pores 331b have pore sizes greater than about 0.1 micrometers (μm). Because the pores 331b have pore sizes greater than about 0.1 μm, the ceramic membrane 331 is used for microfiltration. In some implementations, the pores 331b have pore sizes in a range from about 0.1 μm to about 10 μm or from about 0.1 μm to about 1 μm.

In some implementations, the treated water stream 334 produced by the ceramic membrane MF unit 330 (filtered by the ceramic membrane 331) has an oil content of less than about 10 ppm. In some implementations, the treated water stream 334 produced by the ceramic membrane MF unit 330 (filtered by the ceramic membrane 331) is substantially free of oil. In some implementations, the treated water stream 334 produced by the ceramic membrane MF unit 330 (filtered by the ceramic membrane 331) has an oil content in a range of from 0 ppm to about 10 ppm. In some implementations, the treated water stream 334 produced by the ceramic membrane MF unit 330 (filtered by the ceramic membrane 331) is substantially free of solids. For example, the treated water stream 334 produced by the ceramic membrane MF unit 330 (filtered by the ceramic membrane 331) has a TSS content that is negligible or less than 1 ppm.

Similar to the CPI unit 110, the CPI unit 310 includes a CPI 311. The CPI 311 includes corrugated plates that are tilted at a specified downward angle in a generally parallel configuration to separate phases (such as oil and water) of a fluid (such as the produced water stream 102). The corrugated plates of the CPI 311 have wavy or ridged surfaces which can facilitate separation of phases of a substance (for example, the sludge 332). The sludge 332 passes through the spaces between the corrugated plates of the CPI 311, the lighter phase (such as oil) tends to float while the heavier phases (such as water and solids) tend to settle due to gravity. The oil (for example, in the form of droplets) slides up the corrugated plates and forms an oil layer at the top of the fluid level within the CPI 311 while the water continues to flow down the corrugated plates and exits the CPI 311 as the second treated water stream 314 through a water outlet. The oil layer accumulating at the top of the fluid level within the CPI 311 is skimmed and exits the CPI 311 as the oil stream 312 through an oil outlet. The concentrated sludge 316 can settle at a bottom of the CPI 311 where it can be collected and discharged from the CPI 311, for example, through a solids outlet. In some cases, the CPI 311 includes at least one weir to facilitate separate of the phases of the sludge 332. Increasing the residence time of the sludge 332 through the CPI 311 can improve separation of phases (such as oil, water, and concentrated sludge) of the sludge 332.

In some implementations, the second treated water stream 314 produced by the CPI unit 310 has an oil content of less than about 10 ppm. In some implementations, the second treated water stream 314 produced by the CPI unit 310 is substantially free of oil. In some implementations, the second treated water stream 314 produced by the CPI unit 310 has an oil content in a range of from 0 ppm to about 10 ppm. In some implementations, the second treated water stream 314 produced by the CPI unit 310 is substantially free of solids. For example, the second treated water stream 314 produced by the CPI unit 310 has a TSS content that is negligible or less than 1 ppm.

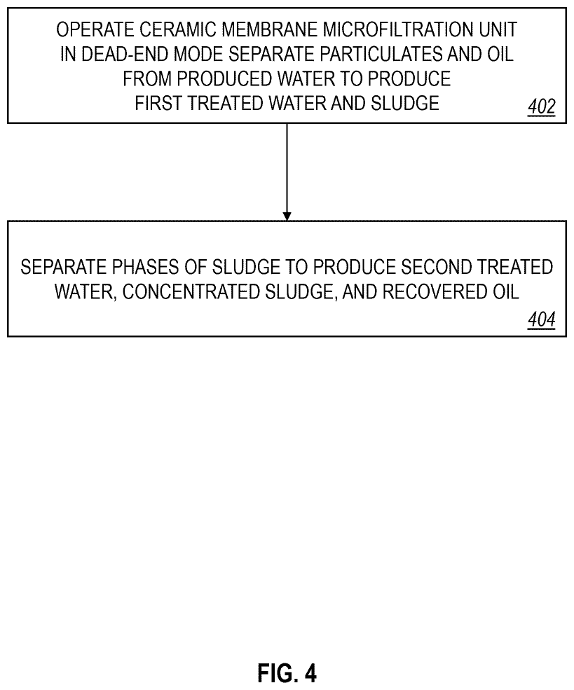

FIG. 4 is a flow chart of an example method 400 for treating produced water (such as the produced water stream 102). The system 300 can, for example, implement the method 400. At block 402, a ceramic membrane MF unit (such as the ceramic membrane MF unit 330) is operated in a dead-end mode to separate phases (such as particulates, oil, and water) from a produced water stream (such as the produced water stream 102) to produce a sludge (such as the sludge 232) and a treated water stream (such as the treated water stream 334). Operating the ceramic membrane MF unit 330 in the dead-end mode includes flowing the produced water stream 102 perpendicularly to a surface (such as the surface 331a) of a ceramic membrane (such as the ceramic membrane 331) of the ceramic membrane MF unit 330. For example, at block 402, the ceramic membrane MF unit 330 is not operated in a cross-flow mode, in which the produced water stream 102 is flowed tangentially across the ceramic membrane 331 (for example, in a direction that is generally parallel to the surface 331a of the ceramic membrane 331). At block 404, phases of the sludge 332 are separated by a CPI unit (such as the CPI unit 310) to produce a recovered oil stream (such as the oil stream 312), a second treated water stream (such as the second treated water stream 314), and a concentrated sludge (such as the concentrated sludge 316).

### EXAMPLES

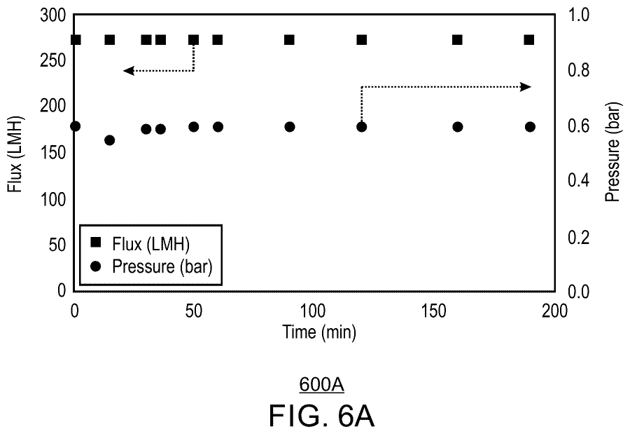

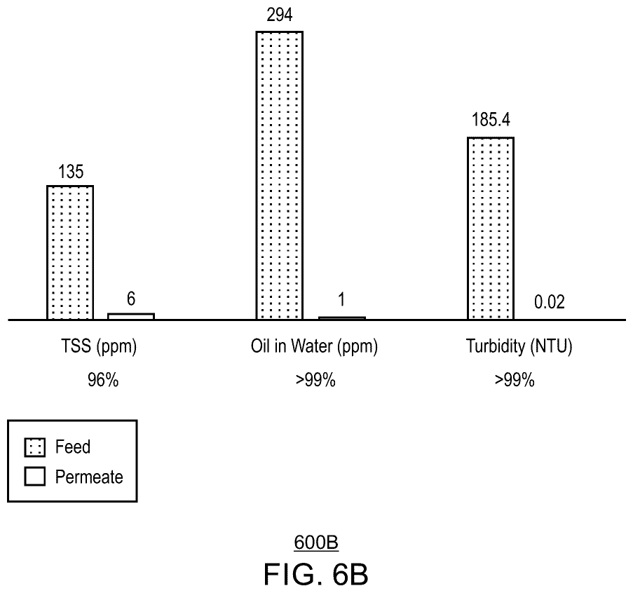

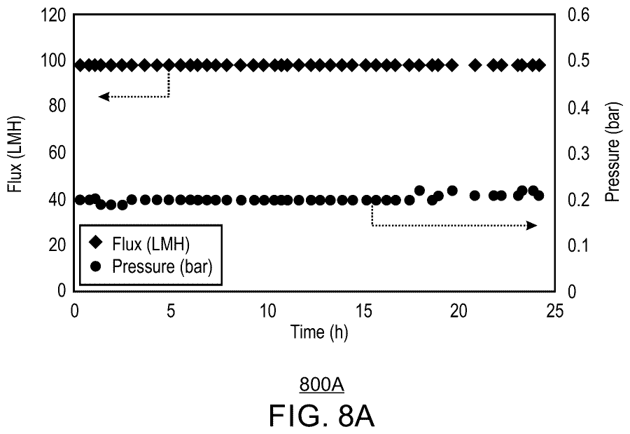

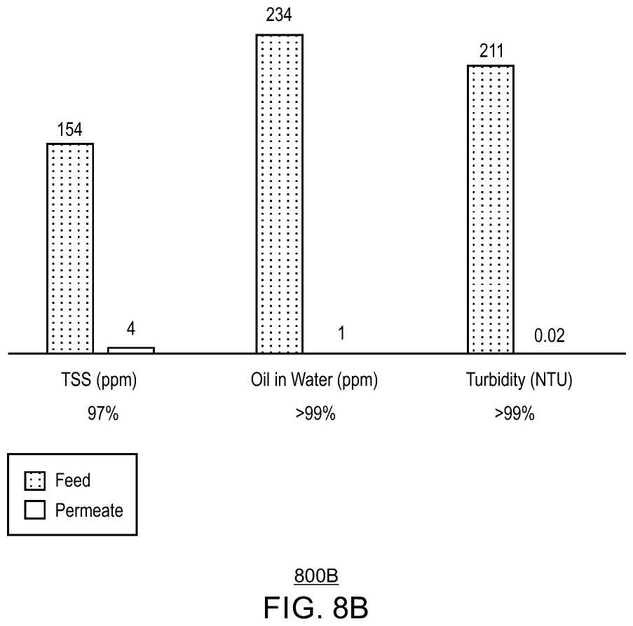

FIG. 5 is a schematic diagram of an example system 500 for treating produced water (such as the produced water stream 102). The system 500 was operated in dead-end mode for various experiments. Produced water was pumped from a feed tank by a feed pump. The feed pump pressurized the produced water to a pressure in a range of from 50 kPa to 300 kPa for filtration. The produced water was then distributed across the ceramic membrane module via a manifold. In the ceramic membrane module, the produced water was forced through the membrane's pores, which were designed to reject oil and suspended solids, allowing clean permeate (water) to pass through. The permeate was collected in a permeate tank, while the contaminants (oil and solids) accumulated on the membrane surface. Because the membrane module of the system 500 was operated in dead-end mode, there was not continuous flow of retentate. The direction of flow was then reversed using the permeate from the permeate tank to push back through the membrane and dislodge/remove the accumulated contaminants. The dislodged/removed contaminants were then returned to the feed tank or directed to a waste tank. The system 500 was then reset to normal operation mode (flow is again reversed) to continue processing of the produced water. The data shown in FIGS. 6A, 6B, 7A, 7B, 8A, and 8B represent results of various experiments performed using the system 500 to test the efficacy of operating a ceramic membrane MF in dead-end mode. These results show the success of operating a ceramic membrane MF in dead-end mode for treating produced water. The dotted arrows in plots 600A, 700A, and 800A (shown in FIGS. 6A, 7A, and 8A, respectively) that point left toward the Flux axis represent the membrane flux which provides how quickly the membrane filters produced water in an hour per square meter. The dotted arrows in plots 600A and 800A (shown in FIGS. 6A and 8A, respectively) that point right toward the Pressure axis represent the differential pressure across the membrane.

FIG. 6A is a plot 600A showing permeate flux and operating pressure over time for an example ceramic membrane treating produced water. The x-axis shows time in minutes. The left y-axis shows permeate flux in liters of permeate (e.g., water) per square meter of membrane area per hour (LMH). The right y-axis shows pressure in bar. As shown by plot 600A, both the permeate flux and the pressure remained relatively constant throughout the experiment. The relatively constant pressure indicates fouling remained under control throughout the experiment.

FIG. 6B is a bar graph 600B representing various properties (TSS, oil content, and turbidity) of the feed and permeate for the example ceramic membrane of FIG. 6A. The feed flowed to the ceramic membrane had a TSS content of 135 ppm, while the permeate exiting the ceramic membrane had a TSS content of 6 ppm, resulting in a 96% reduction of TSS content by employing the ceramic membrane. The feed flowed to the ceramic membrane had an oil content of 294 ppm, while the permeate exiting the ceramic membrane had an oil content of 1 ppm, resulting in a reduction of oil content of more than 99% by employing the ceramic membrane. The feed flowed to the ceramic membrane had a turbidity of 185.4 NTU, while the permeate exiting the ceramic membrane had a turbidity of 0.02 NTU, resulting in a reduction of turbidity of more than 99% by employing the ceramic membrane.

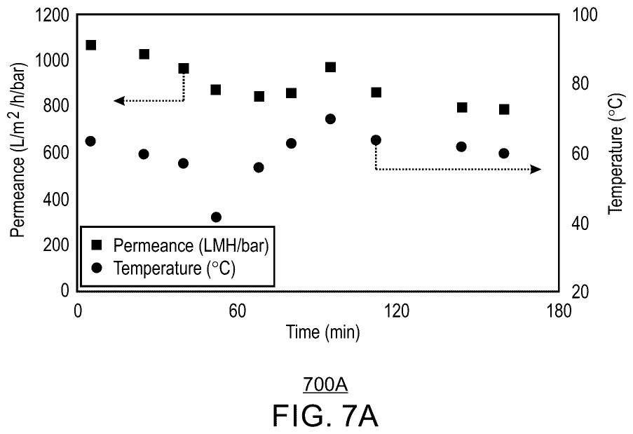

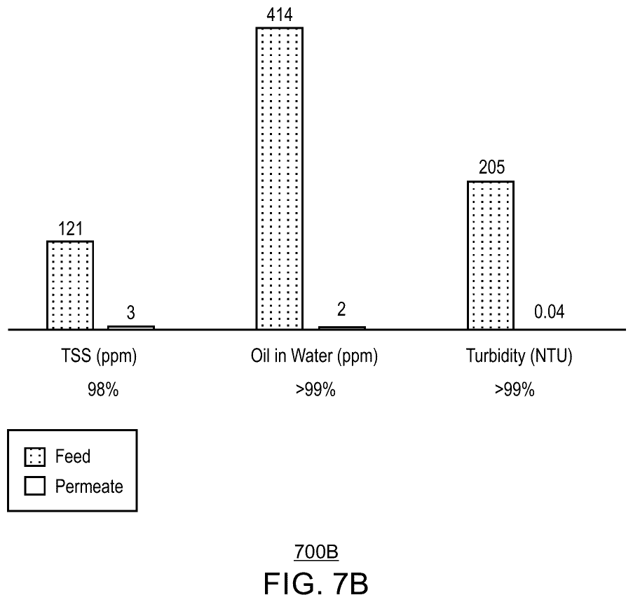

FIG. 7A is a plot 700A showing permeate permeance and operating temperature over time for an example ceramic membrane treating produced water. The x-axis shows time in minutes. The left y-axis shows permeate permeance (flux normalized by pressure) LMH per bar (LMH/bar). The right y-axis shows temperature in degrees Celsius (° C.). As shown by plot 700A, permeate permeance generally matched a similar behavior with temperature throughout the experiment. This behavior shows a direct relationship between permeance and temperature, meaning the membrane's filtration efficiency is at least partially dependent on operating temperature.

FIG. 7B is a bar graph 700B representing various properties of the feed and permeate (TSS, oil content, and turbidity) of the feed and permeate for the example ceramic membrane of FIG. 7A. The feed flowed to the ceramic membrane had a TSS content of 121 ppm, while the permeate exiting the ceramic membrane had a TSS content of 3 ppm, resulting in a 98% reduction of TSS content by employing the ceramic membrane. The feed flowed to the ceramic membrane had an oil content of 414 ppm, while the permeate exiting the ceramic membrane had an oil content of 2 ppm, resulting in a reduction of oil content of more than 99% by employing the ceramic membrane. The feed flowed to the ceramic membrane had a turbidity of 205 NTU, while the permeate exiting the ceramic membrane had a turbidity of 0.04 NTU, resulting in a reduction of turbidity of more than 99% by employing the ceramic membrane.

FIG. 8A is a plot 800A showing permeate flux and operating pressure over a longer period of time in comparison to the example shown in FIG. 6A for an example ceramic membrane treating produced water. The x-axis shows time in minutes. The left y-axis shows permeate flux in LMH. The right y-axis shows pressure in bar. As shown by plot 800A, both the permeate flux and the pressure remained relatively constant throughout the experiment. The relatively constant pressure indicates fouling remained under control throughout the experiment.

FIG. 8B is a bar graph representing various properties of the feed and permeate (TSS, oil content, and turbidity) of the feed and permeate for the example ceramic membrane of FIG. 8A. The feed flowed to the ceramic membrane had a TSS content of 154 ppm, while the permeate exiting the ceramic membrane had a TSS content of 4 ppm, resulting in a 97% reduction of TSS content by employing the ceramic membrane. The feed flowed to the ceramic membrane had an oil content of 234 ppm, while the permeate exiting the ceramic membrane had an oil content of 1 ppm, resulting in a reduction of oil content of more than 99% by employing the ceramic membrane. The feed flowed to the ceramic membrane had a turbidity of 211 NTU, while the permeate exiting the ceramic membrane had a turbidity of 0.02 NTU, resulting in a reduction of turbidity of more than 99% by employing the ceramic membrane.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

### Embodiments

In an example implementation (or aspect), a method comprises: separating, by a corrugated plate interceptor (CPI) unit, a first amount of oil from a produced water stream comprising produced water from a subterranean formation to produce a first pretreated water stream; separating, by a dissolved gas flotation (DGF) unit, a second amount of oil from the first pretreated water stream to produce a second pretreated water stream; and operating a ceramic membrane microfiltration (MF) unit in a dead-end mode to separate particulates from the second pretreated water stream to produce a treated water stream, wherein operating the ceramic membrane MF unit in the dead-end mode comprises flowing the second pretreated water stream perpendicularly to a surface of a ceramic membrane of the ceramic membrane MF unit, wherein the ceramic membrane defines a plurality of pores having pore sizes in a range from about 0.1 micrometers (μm) to about 10 μm.

In an example implementation (or aspect) combinable with any other example implementation (or aspect), the treated water stream has an oil content of less than about 10 parts per million (ppm).

In an example implementation (or aspect) combinable with any other example implementation (or aspect), the produced water stream has an operating temperature of about 60 degrees Celsius (° C.).

In an example implementation (or aspect) combinable with any other example implementation (or aspect), the produced water stream has a flow rate of up to about 800,000 barrels per day (about 127,190 cubic meters per day).

In an example implementation (or aspect) combinable with any other example implementation (or aspect), the produced water stream has an oil content of up to about 1,000 ppm.

In an example implementation (or aspect) combinable with any other example implementation (or aspect), the produced water stream has a total suspended solids (TSS) content of up to about 300 ppm.

In an example implementation (or aspect) combinable with any other example implementation (or aspect), the produced water stream has a turbidity of up to about 250 nephelometric turbidity units (NTUs).

In an example implementation (or aspect) combinable with any other example implementation (or aspect), the second pretreated water stream has an oil content in a range from about 100 ppm to about 1,000 ppm.

In an example implementation (or aspect) combinable with any other example implementation (or aspect), the plurality of pores defined by the ceramic membrane have pore sizes in a range from about 0.1 μm to about 1 μm.

In an example implementation (or aspect) combinable with any other example implementation (or aspect), the ceramic membrane MF unit is not operated in a cross-flow mode in which the second pretreated water stream is flowed tangentially across the ceramic membrane.

In an example implementation (or aspect), a system comprises: a produced water stream comprising produced water from a subterranean formation; a corrugated plate interceptor (CPI) unit comprising a CPI configured to receive the produced water stream and separate a first amount of oil from the produced water stream to produce a first pretreated water stream; a dissolved gas flotation (DGF) unit comprising a DGF pump and a vessel, wherein the DGF pump is configured to flow the first pretreated water stream and a gas into the vessel, wherein the DGF pump is configured to shear the gas to produce fine gas bubbles which facilitate separation of a second amount of oil from the first pretreated water stream to produce a second pretreated water stream; a ceramic membrane microfiltration (MF) unit comprising a flowline and a ceramic membrane defining a plurality of pores having pore sizes in a range from about 0.1 micrometers (μm) to about 10 μm, wherein the flowline is positioned and configured to direct flow of the second pretreated water stream to the ceramic membrane in a direction that is substantially perpendicular to a surface of the ceramic membrane, such that the ceramic membrane is operated in a dead-end mode to discharge a treated water stream and sludge; and the treated water stream discharged by the ceramic membrane MF unit.

In an example implementation (or aspect) combinable with any other example implementation (or aspect), the treated water stream has an oil content of less than about 10 parts per million (ppm).

In an example implementation (or aspect) combinable with any other example implementation (or aspect), the produced water stream has an operating temperature of about 60 degrees Celsius (° C.).

In an example implementation (or aspect) combinable with any other example implementation (or aspect), the produced water stream has a flow rate of up to about 800,000 barrels per day (about 127,190 cubic meters per day).

In an example implementation (or aspect) combinable with any other example implementation (or aspect), the produced water stream has an oil content of up to about 1,000 ppm.

In an example implementation (or aspect) combinable with any other example implementation (or aspect), the produced water stream has a total suspended solids (TSS) content of up to about 300 ppm.

In an example implementation (or aspect) combinable with any other example implementation (or aspect), the produced water stream has a turbidity of up to about 250 nephelometric turbidity units (NTUs).

In an example implementation (or aspect) combinable with any other example implementation (or aspect), the second pretreated water stream has an oil content in a range from about 100 ppm to about 1,000 ppm.

In an example implementation (or aspect) combinable with any other example implementation (or aspect), the plurality of pores defined by the ceramic membrane have pore sizes in a range from about 0.1 μm to about 1 μm.

In an example implementation (or aspect), a system is configured to perform the method of any of the example implementations (or aspects).

What is claimed is:

1. A method comprising:
separating, by a corrugated plate interceptor (CPI) unit, a first amount of oil from a produced water stream comprising produced water from a subterranean formation to produce a first pretreated water stream;
separating, by a dissolved gas flotation (DGF) unit, a second amount of oil from the first pretreated water stream to produce a second pretreated water stream; and
operating a ceramic membrane microfiltration (MF) unit in a dead-end mode to separate particulates from the second pretreated water stream to produce a treated water stream, wherein operating the ceramic membrane MF unit in the dead-end mode comprises flowing the second pretreated water stream perpendicularly to a surface of a ceramic membrane of the ceramic membrane MF unit, wherein the ceramic membrane defines a plurality of pores having pore sizes in a range from about 0.1 micrometers (μm) to about 10 μm.

2. The method of claim 1, wherein the treated water stream has an oil content of less than about 10 parts per million (ppm).

3. The method of claim 2, wherein the produced water stream has an operating temperature of about 60 degrees Celsius (° C.).

4. The method of claim 3, wherein the produced water stream has a flow rate of up to about 800,000 barrels per day (about 127,190 cubic meters per day).

5. The method of claim 3, wherein the produced water stream has an oil content of up to about 1,000 ppm.

6. The method of claim 3, wherein the produced water stream has a total suspended solids (TSS) content of up to about 300 ppm.

7. The method of claim 3, wherein the produced water stream has a turbidity of up to about 250 nephelometric turbidity units (NTUs).

8. The method of claim 3, wherein the second pretreated water stream has an oil content in a range from about 100 ppm to about 1,000 ppm.

9. The method of claim 1, wherein the plurality of pores defined by the ceramic membrane have pore sizes in a range from about 0.1 μm to about 1 μm.

10. The method of claim 1, wherein the ceramic membrane MF unit is not operated in a cross-flow mode in which the second pretreated water stream is flowed tangentially across the ceramic membrane.

11. A system comprising:
a produced water stream comprising produced water from a subterranean formation;
a corrugated plate interceptor (CPI) unit comprising a CPI configured to receive the produced water stream and separate a first amount of oil from the produced water stream to produce a first pretreated water stream;
a dissolved gas flotation (DGF) unit comprising a DGF pump and a vessel, wherein the DGF pump is configured to flow the first pretreated water stream and a gas into the vessel, wherein the DGF pump is configured to shear the gas to produce fine gas bubbles which facilitate separation of a second amount of oil from the first pretreated water stream to produce a second pretreated water stream;
a ceramic membrane microfiltration (MF) unit comprising a flowline and a ceramic membrane defining a plurality of pores having pore sizes in a range from about 0.1 micrometers (μm) to about 10 μm, wherein the flowline is positioned and configured to direct flow of the second pretreated water stream to the ceramic membrane in a direction that is substantially perpendicular to a surface of the ceramic membrane, such that the ceramic membrane is operated in a dead-end mode to discharge a treated water stream and sludge; and
the treated water stream discharged by the ceramic membrane MF unit.

12. The system of claim 11, wherein the treated water stream has an oil content of less than about 10 parts per million (ppm).

13. The system of claim 12, wherein the produced water stream has an operating temperature of about 60 degrees Celsius (° C.).

14. The system of claim 13, wherein the produced water stream has a flow rate of up to about 800,000 barrels per day (about 127,190 cubic meters per day).

15. The system of claim 13, wherein the produced water stream has an oil content of up to about 1,000 ppm.

16. The system of claim 13, wherein the produced water stream has a total suspended solids (TSS) content of up to about 300 ppm.

17. The system of claim 13, wherein the produced water stream has a turbidity of up to about 250 nephelometric turbidity units (NTUs).

18. The system of claim 13, wherein the second pretreated water stream has an oil content in a range from about 100 ppm to about 1,000 ppm.

19. The system of claim 11, wherein the plurality of pores defined by the ceramic membrane have pore sizes in a range from about 0.1 μm to about 1 μm.

20. A system configured to perform the method of claim 1.
